(19) United States
(12) Patent Application Publication
(10) Pub. No.: US 2024/0091719 A1
(43) Pub. Date: Mar. 21, 2024

(54) APPARATUS AND METHOD FOR ACCELERATED DISSOLUTION OF CARBONATES WITH BUFFERED PH

(71) Applicant: Limenet S.r.l. Società Benefit, Galbiate (IT)

(72) Inventor: Giovanni CAPPELLO, Galbiate (IT)

(73) Assignee: Limenet S.r.l. Società Benefit, Galbiate, LC (IT)

(21) Appl. No.: 18/262,967

(22) PCT Filed: Feb. 18, 2022
(86) PCT No.: PCT/IB2022/051464

§ 371 Date: Jul. 26, 2023

(30) Foreign Application Priority Data
Feb. 19, 2021 (IT) 102021000003263

(51) Int. Cl. B01F 21/00; B01F 21/20

(52) U.S. Cl. CPC B01F 21/02; B01F 21/20; B01F 21/40; B01F 2215/0477

(57) ABSTRACT

An apparatus for accelerated dissolution of carbonates with buffered pH. The apparatus includes a mixer, a dissolution reactor and a pH correction reactor. The mixer includes: a chamber; a water supply; a carbonic gas supply; and a carbonate supply. Water, carbonic gas and carbonate are provided to the chamber in predetermined continuous flow rates to obtain a design flow rate of lean mixture at the outlet. The dissolution reactor includes a duct connected to the chamber receiving the lean mixture and allowing at least partial dissolution of the carbonate which transforms the lean mixture into an ionic mixture according to the reaction CaCO3+CO2+H2O□ Ca(HCO3)2. The pH correction reactor comprises a duct and a hydroxide supply. The mixture is then released into the sea. Embodiments also relate to a method for the accelerated dissolution of carbonates with buffered pH for the permanent sequestration of CO2 in the sea in the form of bicarbonates.

The subject of the present invention is an apparatus and a method for the accelerated dissolution of carbonates or, in other words, for the generation of a pH-buffered ionic mixture, in an economical and environmentally sustainable form.

The effects of so-called “greenhouse gases” on the climate have long been known, especially the correlation between the concentration of CO₂ (carbon dioxide) in the atmosphere and global warming.

The efforts of the world's scientific and political community in recent years have been concentrated on trying to counteract the increase in greenhouse gas emissions into the atmosphere, in order to prevent the phenomenon of global warming, i.e. the rise in the average global temperature.

As is well known, a number of initiatives have been promoted at international level to limit CO₂ emissions into the atmosphere: the Kyoto Protocol in 1997 and the Paris Agreement in 2015, among others, are worth mentioning.

The ways identified by the scientific community to prevent global warming are multiple and basically concern the decrease in the use of fossil fuels such as coal, oil and natural gas by promoting the development of renewable energies such as hydro, wind, solar and biomass energy.

In addition, many efforts of the international community are focused on improving the efficiency of energy use, such as lighting with low-consumption light bulbs, transport with new generations of high-efficiency engines and, in the field of power generation, replacing old, inefficient coal- or oil-fired power stations with new combined-cycle gas turbine and steam turbine plants with energy efficiencies approaching 60%.

Despite the technological efforts being made in the most advanced nations, forecasts by well-known international institutions of global energy needs over the next few years indicate a sharp increase in demand for electricity, thermal energy for industry and fuels for transport.

As a result, these forecasts unfortunately still indicate an increase in the use of fossil fuels such as oil, coal and natural gas, especially by emerging, newly industrialised and developing countries as the development of renewable energies and the possibility of storing CO₂ in permanent form from fossil fuel plants are not growing at the rate needed to meet the goals of the Paris agreement of 2015.

Using the data provided by these authoritative studies, a rapid decrease in CO₂ emissions to counteract global warming is not expected at global level in the near future, despite the efforts and environmental policies implemented by several countries, mainly due to the increase in world population and the new industrialisation of entire countries.

Different technologies have been proposed to capture and sequestrate the CO₂ produced by industrial and power generation plants using fossil fuels. Generally, all these technologies involve separating CO₂ from other gases by chemical/physical means.

Most of the proposed capture and storage technologies relate to concentrated CO₂ emissions such as those present in the flue gas of power plants or industrial installations.

The main CCS technologies proposed and known are:
sequestration of CO₂ in deep saline aquifers, a method recognised and promoted by the European Union through a 2009 directive;
sequestration of CO₂ directly to the ocean floor in liquid form;
sequestration of CO₂ in calcium carbonates or calcium silicates, either directly or with the use of peptoids, known as Mineral Carbonation;
sequestration of CO₂ in oil wells where it is injected to increase the oil production of the well itself with technology called EOR (Enhanced Oil Recovery);
sequestration of CO₂ in glass-ceramic capsules in the deep sea using technology called SCS (Submarine Carbon Storage) proposed in international patent application WO 2016/088002 A1;
sequestration of CO₂ using calcium bicarbonates with technology called EWL (Enhanced Weathering Limestone) or accelerated dissolution of carbonates proposed in U.S. Pat. No. 6,890,497 B2 entitled “Method for extracting and sequestering carbon dioxide” and Korean patent KR 101888 684 B1 entitled “Neutralization and concentration reaction system for ocean sequestration of carbon dioxide”.

Sequestration of CO₂ using EWL technology has considerable advantages over other known technologies because the availability of carbonate rocks is very large, because the sea is very rich in bicarbonates and therefore the addition of new bicarbonates does not pose any environmental problems, because it does not require the monitoring of the storage site and because the technology can be used in modular plants and its application can be industrialised and programmable.

Sequestration of CO₂ with EWL reactors as proposed and described in the U.S. Pat. No. 6,890,497 B2 and KR 101888 684 B1 and by numerous scientific articles has some important problems that limit its applicability such as the large quantities of water needed for the process, the long reaction times, the possible acidification of seawater and the problems of CO₂ outgassing and the consequent decrease in storage efficiency.

In fact, the EWL technologies proposed up to now envisage a reactor in which the reaction of carbonate dissolution with water and CO₂ takes place, and the release of an ionic solution of bicarbonates into the sea through a duct whose sole function is to convey the ionic solution of bicarbonates into the sea and in which no chemical reactions of carbonate dissolution take place.

From the published scientific literature on EWL technology, it is easy to see that, in the best-case scenario, about 3,800 m³ of seawater is needed to store one tonne (one metric ton, i.e. 1000 kg) of CO₂ in the form of bicarbonates, and that this amount of bicarbonate-rich water is the water that must be discharged into the sea through a special duct.

Moreover, the scientific literature published on EWL technology and the results of the experimental plants built show that the ionic mixture discharged by the EWL reactors proposed so far has a pH of approximately 6 and that, if discharged into the deep sea, it would lead to the acidification of the sea, while if the ionic mixture discharged by the EWL reactors were discharged into surface waters it would have to be degassed, with a significant loss of CO₂ storage efficiency.

In EWL technology, releasing an effluent already in an ionic state (ionic mixture), in which all the carbonate is dissolved in the effluent, implies the use and transport of large quantities of water to the desired depth and long residence times, even tens of hours, which in the reactors proposed so far installed on land makes this option technically and economically impracticable, also because of the enormous size of the reactors themselves.

As can be immediately understood, there is a need to find a method and an apparatus that will allow carbonates to be dissolved in an accelerated form using low quantities of water, without acidifying the sea, with greater efficiency than the EWL reactors proposed so far and with an acceptable cost to allow its rapid and massive application.

The task of the present invention is to make available a method and apparatus that can enable the complete dissolution of the carbonates present in a mixture of CO₂, water and carbonates and the release into the sea of an ionic mixture of water and bicarbonates with a pH similar to that of the sea for the permanent storage of CO₂, which can be realised in modular form and implemented on a global scale.

Said purpose and tasks are achieved by means of an apparatus and method for the accelerated dissolution of carbonates with buffered pH according to claims 1 and 12, respectively. The method according to the invention may also be called BEWL (BUFFERED ENHANCED WEATHERING of LIMESTONE).

In order to better understand the invention and appreciate its advantages, some exemplary and non-limiting embodiments of the invention are described below, with reference to the accompanying drawings, in which:

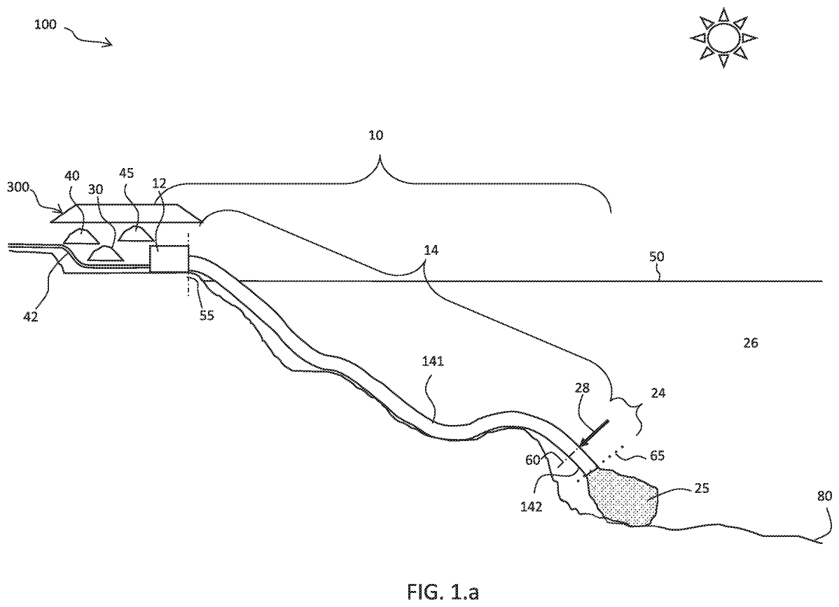

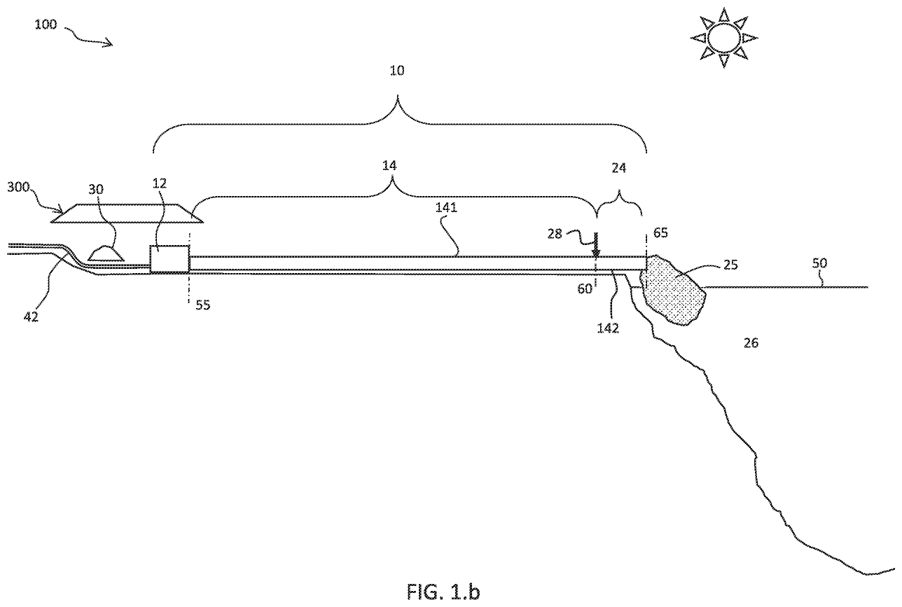

FIG. 1.a is a schematic view of a possible embodiment of an apparatus for the accelerated dissolution of carbonates from a fixed platform according to the invention;

FIG. 1.b is a schematic view of a possible embodiment of an apparatus for the accelerated dissolution of carbonates from a fixed platform according to the invention;

FIG. 1.c is a schematic view of a possible embodiment of an apparatus for the accelerated dissolution of carbonates from a fixed platform according to the invention;

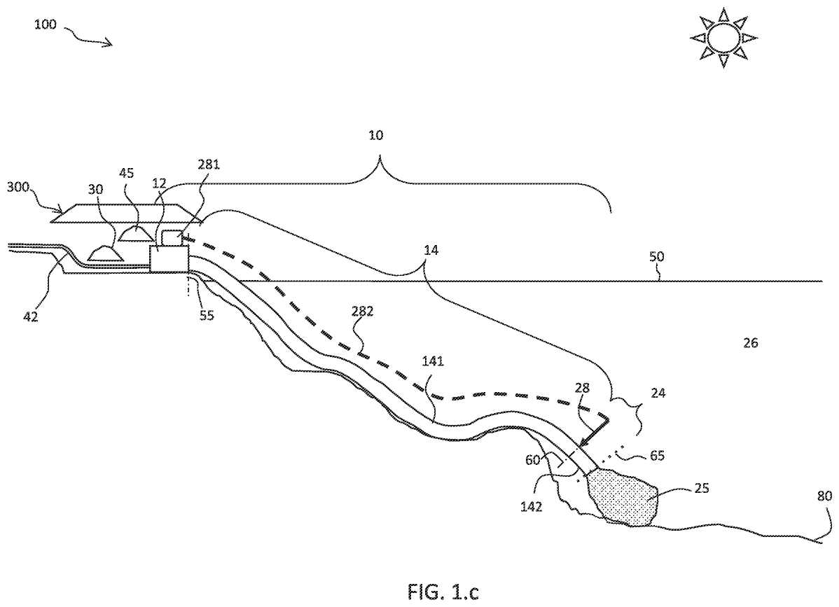

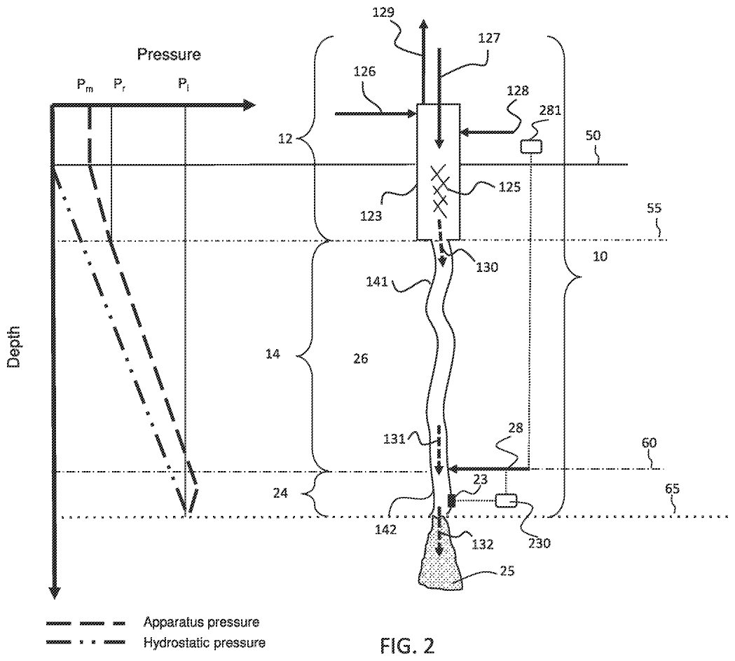

FIG. 2 is a schematic view of a possible embodiment of an apparatus for the accelerated dissolution of carbonates according to the invention, wherein the pressure trend inside the apparatus is schematically represented;

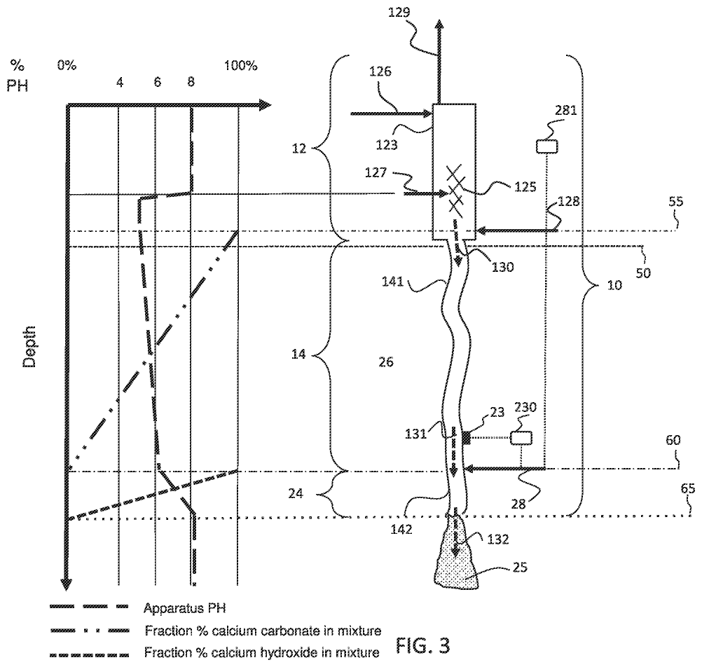

FIG. 3 is a schematic view of a possible embodiment of an apparatus for the accelerated dissolution of carbonates according to the invention and the trend is schematically represented of pH and of the amount of carbonates/hydroxides;

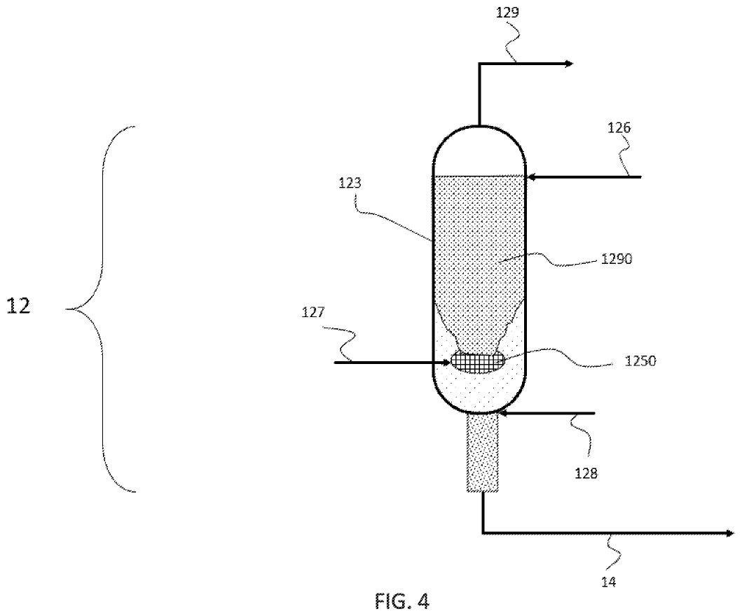

FIG. 4 is a schematic view of a possible embodiment of the mixer 12 according to the invention.

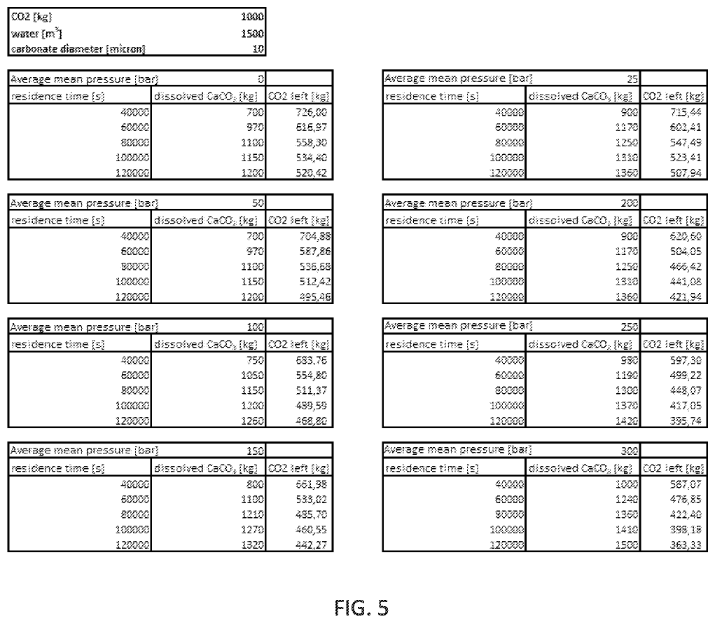

FIG. 5 represents a table of unreacted CO₂ (kg) inside reactor 14 measured in the section 60 and fully reacted CaCO₃ (kg) inside the reactor 14 upstream of the section 60, as a function of the weighted average pressure inside the reactor and the residence time;

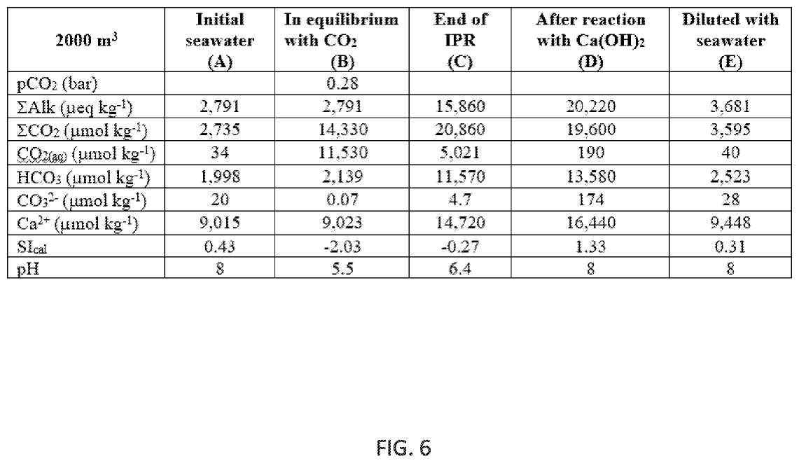

FIG. 6 represents a table of possible values of CO₂, carbonates, bicarbonates and pH in the various sections of an apparatus for the accelerated dissolution of carbonates with buffered pH according to the invention.

In the description, reference will be made to “carbonic gas”, meaning a gas mixture containing CO₂, and possibly other substances including H₂, CO, CH₄, N₂, O₂, H₂S, SO₂, NO, whereas when reference is made to the chemical element CO₂ (carbon dioxide) alone, CO₂ will be used the description.

In the description, reference will also be made to “water”, meaning sea or lake water, fresh, salt or brackish, whereas when reference is made to the chemical element H₂O alone in the description, H₂O will be used the description.

In the description, reference will also be made to the “sea”, meaning not only the sea itself, but also an ocean or any salt or brackish water.

In the description, reference will also be made to the “depth” of the sea, meaning the vertical distance from the sea level in the direction of the force of gravity; in particular, a greater or larger “depth” means a longer distance from the sea surface and a lesser or smaller “depth” means a shorter distance from the sea surface.

In the description reference will also be made to the “weighted average pressure”, meaning the sum of the pressures within the dissolution reactor 14 multiplied by the residence time and divided by the total time according to the formula:

$$\frac{{\sum }_{i = 1}^{n} Pi \times Si}{{\sum }_{i = 1}^{n} Si}$$

where Pi is the pressure in time interval i and Si is the duration time of time interval i.

In the description, reference will be made to a “reactor”, meaning an apparatus in which chemical reactions take place in a continuous way rather than in batch form.

In the description, reference will be made to a “chamber” meaning a part of the mixer 12 in which the formation of a lean mixture (defined below) takes place irrespective of its shape and size.

In the description, reference will be made to “carbonate” or “carbonates”, meaning a solid material consisting mainly of CaCO₃ and MgCO₃ in particle sizes comprised between 0.1 microns and 50 microns, even in an aqueous suspension. When reference is made to the chemical element CaCO₃ or MgCO₃ alone, the description will use CaCO₃ or MgCO₃, respectively. In the description and the formulae, CaCO₃ will be used as an example of a carbonate, with the understanding that the arguments are also valid for MgCO₃ and for carbonate rocks containing them in various proportions, such as limestone, dolomite CaMg(CO₃)₂, marble and travertine.

In the description, reference will be made to “aragonite”, meaning a carbonate formed mainly from CaCO₃ that crystallises in the bipyramidal rhombic class and is a polymorph of calcite precipitated from seawater in biotic form. Aragonite can be found in many marine organisms, shells, corals and consequently in coral and “Oolitic aragonite sands” of which the Bahamas has large deposits.

In the description, reference will be made to “calcite”, meaning a carbonate formed mainly from CaCO₃ that crystallises in the trigonal class. Calcite is commonly found in limestone or dolomitic deposits and is the most widespread carbonate in the earth's crust.

In the description, reference will be made to “bicarbonates”, meaning the chemical compounds Ca(HCO₃)₂ and Mg(HCO₃)₂. In the description and in the formulae, Ca(HCO₃)₂ will be used as an example of bicarbonates, it being understood that the reasoning also applies to Mg(HCO₃)₂.

In the description, reference will be made to “hydroxide”, meaning calcium hydroxide Ca(OH)₂, magnesium hydroxide Mg(OH)₂ in powder or suspension form or in solution with an appropriate quantity of water. In the description and in the formulas, Ca(OH)₂ will be used as an example of a hydroxide, it being understood that the reasoning also applies to Mg(OH)₂, for the hydroxide obtained from the calcination of minerals containing them, such as calcite, aragonite, dolomite and magnesite.

In the description, reference will be made to the “mixture”, meaning a slurry of water, CO₂, carbonate, bicarbonates and impurities in which the percentage by weight of carbonates in the mixture is comprised between 0% and 10% and in which some elements, such as carbonates and solid impurities, are in suspension and other elements, such as CO₂ and bicarbonates, are in solution.

In the description, reference will be made to the “design flow rate”, meaning the sum of the quantities of water, CO₂, carbonates, bicarbonates and impurities that are released in the unit of time from the mixer 12 to the dissolution reactor 14 and that allows the permanent sequestration of a predetermined quantity of CO₂.

In the description, reference will be made to the “lean mixture”, meaning a slurry of water, CO₂, carbonates, bicarbonates and impurities in which the proportion of carbonates which have dissolved in the water supplied to mixer 12 in relation to the carbonates supplied to the mixer 12 is less than 10%. A solution of only water and CO₂ in which no carbonates are present is also considered a lean mixture.

In the description, reference will be made to the “ionic mixture”, meaning a mixture where all the carbonate present has dissolved and the Ca²⁺ or Mg²⁺ is in ionic form. An ionic mixture is also considered to be a solution of only water and CO₂ in which no carbonates are present; in this particular case the lean mixture chemically coincides with the ionic mixture.

In the description, reference will be made to “buffered ionic mixture”, meaning an “ionic mixture” in which the pH has been corrected to the desired value by the addition of a hydroxide. In cases where the hydroxide is readily soluble, the “buffered ionic mixture” is an ionic solution. In cases where the hydroxide has low solubility due, for example, to high Mg content, the “buffered ionic mixture” may be a slurry formed from the “ionic mixture” and the undissolved hydroxide.

In the description, reference will be made to “Ω_{cal}” meaning the calcite saturation state in seawater. The SI_{cal} (Saturation Index Calcite) referred to in the attached figures is related to f_{c}a by the formula SI_{cal}=log₁₀(Ω_{cal}).

In the description reference will be made to “impurities” meaning solid, liquid or gaseous substances present in the carbonate, in the gas containing CO₂ or in the water which do not take part in the chemical reactions according to the invention.

In the description, reference will be made to the “plume”, i.e. the portion of the sea where the mixture released from the reactor is mixed and diluted with the surrounding sea water.

In the description, reference will be made to the “residence time of the mixture”, i.e. the time in which the mixture is able to pass through the duct 141.

In the description, reference will be made to “pH”, meaning the measurement scale that indicates the acidity or basicity of a liquid which is defined by the following formula:

pH=−log₁₀[H₃O⁺]

In the description, reference will be made to “alkalinity”, meaning the amount of hydroxides OH⁻, carbonates CO₃²⁻ and bicarbonates HCO₃²⁻ present in seawater.

In the description reference will be made to “hardness” meaning a value expressing the total content of Ca²⁺ and Mg²⁺ ions in seawater.

In the description, reference will be made to the “carbonate dissolution reaction”, meaning the following reaction:

CO2(g)+CaCO3(s)+H2O=>Ca2⁺(aq)+2HCO3⁻(aq) [1]

where Ca²⁺ can be replaced by Mg²⁺ if present in the carbonate.

In the description, reference will be made to the “Reynolds number Re”, meaning the dimensionless number used in fluid dynamics proportional to the ratio between the inertia forces and viscous forces.

In the description reference will be made to “OD” meaning Outside Diameter, or the diameter of a pipe with a circular section or a circular tubular structure with the same hydraulic characteristics as the tubular structure under consideration.

In the description, reference will be made to the “SDR”, meaning the Standard Dimensional Ratio of a pipe defined as the ratio of the outside diameter OD to the wall thickness of the pipe.

In the description, reference will be made to “PE”, meaning the plastic material HDPE—High Density Poly Ethylene or LDPE—Low Density Poly Ethylene;

In the attached figures, an apparatus for the accelerated dissolution of carbonates with buffered pH is indicated overall by the reference 100. The apparatus 100 may advantageously comprise one or more of the following components: a logistics base 300, a storage facility 40 for carbonic gas (not shown in the figures), a carbonate storage facility 30, a hydroxide storage facility 45, an apparatus 10 for preparing a buffered ionic mixture by total reaction of carbonate with water and CO₂ in the dissolution reactor 14 and final pH correction by hydroxide in the pH correction reactor 24. The logistics base 300 may include an off-shore platform or a ship (not shown in the figures).

The apparatus 100 may further comprise means 42 for supplying carbonic gas. For example, the logistics base 300 can be connected to an appropriate pipeline for transporting the carbonic gas. More specifically, the off-shore platform can be connected to the coast by a suitable pipeline for transporting the carbonic gas or housing a plant on board to produce it. Alternatively, other known methods of transporting carbonic gas can be used, e.g. by means of pressurised containers loaded onto special transport vehicles and/or vessels.

The apparatus 100 for the accelerated dissolution of carbonates with buffered pH, comprises a mixer 12, a dissolution reactor 14 and a pH correction reactor 24 wherein the mixer 12 comprises:
a chamber 123;
means for supplying water 126;
means for supplying carbonic gas 127;
means for supplying carbonate 128; and wherein:
the water supply means 126 are adapted to provide a predetermined continuous flow of water to the chamber 123;
the carbonic gas supply means 127 are adapted to provide a predetermined continuous flow of CO₂ to the chamber 123;
the carbonate supply means 128 are adapted to provide a predetermined continuous flow of carbonate to the chamber 123;
the chamber 123 is hydraulically connected to the dissolution reactor 14 to release a design flow rate of a lean mixture 130 at the outlet;
   and wherein the dissolution reactor 14 comprises a duct 141, wherein:
the duct 141 is hydraulically connected to the chamber 123 to receive a design flow rate of a lean mixture 130;
the duct 141 is adapted to convey the lean mixture 130;
the duct 141 is adapted to enable at least the partial dissolution of the carbonate which transforms the lean mixture 130 into an ionic mixture 131 according to the reaction

CaCO₃+CO₂+H₂O→Ca(HCO₃)₂
wherein Ca²⁺ can be replaced by Mg²⁺ if present in the carbonate;
the duct 141 has a diameter OD comprised between 30 mm and 8000 mm (8 m), preferably between 100 mm and 2500 mm (2.5 m);
the duct 141 has a length of less than 200000 m (200 km), preferably comprised between 10 m and 20000 m (20 km);
the duct 141 is adapted to continuously release a design flow rate of ionic mixture 131 to the pH correction reactor 24;
   and wherein the pH correction reactor (24) comprises a duct 142 and hydroxide supply means 28, wherein:
the duct 142 is hydraulically connected to the duct 141 to receive a design flow rate of ionic mixture 131 released from the dissolution reactor 14;
the hydroxide supply means 28 are suitable for supplying a predetermined amount of hydroxide to the pH correction reactor 24;
the pH correction reactor 24 is adapted to mix the hydroxide 28 with the ionic mixture 131 to form a buffered ionic mixture 132 with desired pH according to the reaction

Ca(OH)₂+2CO₂→Ca(HCO₃)₂
wherein Ca²⁺ can be replaced by Mg²⁺ if present in the carbonate;
the duct 142 of the pH correction reactor 24 has a diameter OD comprised between 30 mm and 8000 mm (8 m), preferably the same diameter as the duct 141;
the duct 142 of the pH correction reactor 24 has a length, measured between the section 60 where the hydroxide supply means 28 are positioned and the section 65 where the buffered ionic mixture 132 is released into the sea, comprised between 0 m and 20000 m (20 km), preferably between 10 m and 1000 m; and
the duct 142 of the pH correction reactor 24 is hydraulically connected to the sea and is adapted to release the buffered ionic mixture 132 into the sea.

In accordance with some embodiments of the invention, the apparatus 100 for the accelerated dissolution carbonates with buffered pH further comprises mixing means 125 adapted to uniformly disperse the carbonic gas and carbonate in water so as to form the lean mixture 130.

In accordance with some embodiments, the apparatus 100 for the accelerated dissolution of carbonates with buffered pH further comprises means for evacuating non-soluble gases 129.

In accordance with some embodiments of the invention, the apparatus 100 for the accelerated dissolution carbonates with buffered pH comprises a dissolution reactor 14 in which the duct 141 is made of plastic material, preferably PE, with an SDR>11, preferably with 33≤SDR≤50.

In accordance with some embodiments of the invention, the apparatus 100 for the accelerated dissolution carbonates with buffered pH is at least partially installed in the sea. In this case, the apparatus 100 is preferably anchored to the seabed.

In accordance with some embodiments of the invention, for example those schematically depicted in FIGS. 2 and 3, the apparatus 100 for the accelerated dissolution carbonates with buffered pH further comprises a meter 23 and a control unit 230, wherein:
the meter 23 is adapted to measure the pH and/or the alkalinity and/or the hardness of the ionic mixture 131 or the buffered ionic mixture 132 and to provide the measurement to the control unit 230;
the control unit 230 is adapted to receive the measurement from the meter 23; and
the control unit 230 is adapted to process the measurements received and to command the hydroxide supply means 28 to supply the pH correction reactor 24 with the quantity of hydroxide necessary to obtain a buffered ionic mixture 132 with a desired pH.

In accordance with some embodiments of the invention, for example that shown schematically in FIG. 1c, the apparatus 100 for the accelerated dissolution carbonates with buffered pH further comprises a hydroxide dispenser 281 and an auxiliary pipe 282, wherein:
the hydroxide dispenser 281 is part of the hydroxide supply means 28;
the hydroxide dispenser 281 is adapted to receive hydroxide at the inlet and to release a predetermined quantity of hydroxide 28 at the outlet, as commanded by the control unit 230;
the auxiliary hydroxide transport pipe 282, forming part of the hydroxide supply means 28, is adapted to receive at the inlet the predetermined amount of hydroxide 28 released from the hydroxide dispenser 281 and to release the predetermined amount of hydroxide 28 at the outlet to the pH control reactor 24; and
the auxiliary hydroxide transport pipe 282 is adapted to transport the predetermined flow rate of hydroxide 28.

Preferably the auxiliary pipe 282 for transporting hydroxide 28 connects the hydroxide storage facility 45 with the section 60 where the hydroxide supply means 28 are positioned.

In accordance with some embodiments of the invention, the auxiliary hydroxide transport pipe 282 runs parallel or coaxial to the duct 141.

In accordance with some embodiments of the invention, the mixer 12 and the dissolution reactor 14 may be implemented as a single seamlessly integrated apparatus between the mixer 12 and the dissolution reactor 14. In such a case, the section 55 represents the section where the dissolution reactor 14 is hydraulically connected to the mixer 12 and where the lean mixture 130 begins to be present.

In accordance with some embodiments of the invention, the dissolution reactor 14 and the pH correction reactor 24 may be implemented as a single, seamlessly integrated apparatus between the dissolution reactor 14 and the pH correction reactor 24. In such a case, the section 60 represents the section where the dissolution reactor 14 is hydraulically connected to the pH correction reactor 24 and where the hydroxide supply means 28 are positioned.

In accordance with some embodiments of the invention, the mixing means 125 positioned in the mixer 12 may be implemented by means of spray nozzles, static mixers, scrubber packing or, referring to FIG. 4, by means of suitable carbonic gas diffusers 1250 that generate microbubbles 1290 in the water contained in the chamber 123 and allow the hydration of CO₂ by means of the equation

CO₂+H₂O→H₂CO₃→H⁺+HCO₃⁻.

Referring to the embodiments of FIGS. 1a, 1b, 1c, 2, 3 and 4, it is also possible to identify:
the mixer 12 for mixing carbonate with water and CO₂;
means for supplying carbonic gas 127;
means for supplying carbonate 128;
means for supplying water 126;
means for evacuating gases that are not very water-soluble 129;
the chamber 123 of mixer 12;
the mixing means 125;
the carbon gas bubbles 1290 generated by the diffuser 1250;
the dissolution reactor 14 which allows total dissolution of the carbonate;
the duct 141, which transports the mixture from the section 55 to the section 60;
the plume 25 formed on release of the buffered ionic mixture 132;
the seawaters 26;
the surface level of the sea 50;
the section 55 which is the section in which the dissolution reactor 14 is hydraulically connected to the mixer 12;
the section 60 which is the section in which the dissolution reactor 14 is hydraulically connected to the pH correction reactor 24;
the section 65 in which the buffered ionic mixture 132 is released into the sea from the pH correction reactor 24;
the lean mixture 130 released from the mixer 12 and at the inlet to the dissolution reactor 14;
the sea bed 80;
the flow of ionic mixture 131 released from the dissolution reactor 14 and that supplies the pH correction reactor 24;
the means for supplying hydroxide 28 to the pH correction reactor 24;
the flow of buffered ionic mixture 132 released from the pH correction reactor 24;
the pH and/or alkalinity and/or hardness sensor 23;
the control unit 230;
the hydroxide dispenser 281 forming part of the hydroxide supply means 28;
the auxiliary pipe 282, forming part of the hydroxide supply means 28, for transporting the hydroxide from the dispenser 281 to the pH correction reactor 24.

In accordance with the embodiments of the apparatus 10 according to the invention represented schematically in FIGS. 1a, 1b, 1c, 2 and 3, the dissolution reactor 14 comprises at least one duct 141 which may be vertical, horizontal or differently inclined, preferably of circular cross-section, straight or curved, suitable for the passage of a mixture of water, carbonate particles, impurities, carbonic gas and which hydraulically connects the mixer 12 to the pH correction reactor 24.

In accordance with the embodiments schematically represented in FIGS. 1a, 1b, 1c, 2 and 3, the pH correction reactor 24 comprises at least one duct 142 which may be vertical, horizontal or differently inclined, preferably of circular cross-section, straight or curved, with water-impermeable or permeable walls, closed or partially closed by walls, suitable for the passage of a mixture of water, bicarbonates, impurities, carbonic gas, hydroxide and which hydraulically connects the dissolution reactor 14 to the sea.

In a known form, the carbonate dissolution process is a process with very slow kinetics which therefore requires very long residence times in the reactor of the water, CO₂ and carbonate mixture and very large contact surfaces between the carbonate and the water.

An experienced person can clearly understand that using micron-sized carbonate particles instead of millimetre-sized carbonate particles increases the contact surface between carbonate and water in the mixture and promotes the dissolution reaction.

In a known form, the carbonate dissolution reaction is favoured by low pH and strongly undersaturated mixtures compared to calcite, i.e. with negative SI.

In a known form, as the partial pressure of CO₂ increases, the degree of hydration of CO₂ increases, the formation of carbonic acid H₂CO₃ and the consequent decrease in pH.

As stated above, the solubility of carbonate in water increases as the pH decreases and the pressure increases within the saturation limits of Ca²⁺ in the water. Low pH levels and high pressures promote the dissolution of the carbonate which, as it dissolves, consumes the CO₂ dissolved in the water, thus increasing the pH of the mixture inside the dissolution reactor 14.

An experienced person will certainly understand the advantages of using a tubular reactor which can easily be placed on the seabed and thus take advantage of hydrostatic pressure, can be very long with high residence times of the mixture, can easily keep the mixture inside it in a turbulent regime allowing it to easily handle finely micronised carbonate by optimising the reaction surface thereof.

An experienced person will, as mentioned above, certainly understand that by placing the dissolution reactor 14 on the seabed, it is possible to conveniently exploit the hydrostatic pressure proportional to the installation depth of the dissolution reactor 14 by promoting carbonate dissolution reactions according to the reaction [1].

An experienced person can easily deduce that according to the reaction [1] and considering the special case in which the carbonate was calcite or aragonite, about 2272 kg of CaCO₃ and about 409 kg di H₂O are required to stoichiometrically react 1000 kg of CO₂.

An experienced person will certainly understand that the amount of water in the lean mixture 130 required to keep the mixture sufficiently fluid and to obtain complete dissolution of the carbonate and thus the ionic mixture 131, is greater than the stoichiometric quantities required according to equation [1].

In accordance with some embodiments of the invention, and with particular reference to FIG. 3, the amount of carbonate, water and CO₂ fed to the mixer 12 are established so that all of the carbonate supplied to the mixer 12 can react in the dissolution reactor 14 with the water and CO₂ to form an ionic mixture 131 according to equation [1].

An experienced person can readily understand if it is desired that all the carbonate fed to mixer 12 be dissolved in the dissolution reactor 14, it is desirable to supply to the mixer 12, for the same amount of CO₂, less carbonate than is required stoichiometrically according to equation [1] with the result that in the ionic mixture 131 released from the dissolution reactor 14 there is a quantity of CO₂ that has not reacted with the carbonate which, if discharged into the sea, would lower its pH unless properly buffered with a basic substance. All the carbonate supplied to the reactor 12 and not reacted with CO₂ at the end of the dissolution reactor 14 would be released into the sea in a solid state with the ionic solution 131 or buffered ionic solution 132 and represents a waste of material.

Referring to FIGS. 5 and 6, an experienced person may agree that it is possible to construct, using appropriate and in itself known calculation models tables with the amount of dissolved CaCO₃ and CO₂ left unreacted in the ionic mixture 131 released from the dissolution reactor 14 referring to a duct 141 as a function of the residence time of the mixture in the dissolution reactor 14 and as a function of the weighted average pressure (WAP) inside the dissolution reactor 14, the initial carbonate diameter of the CaCO₃ and the amount of water used. The hypothesis adopted in the tables in FIG. 5 is to react 1000 kg of CO₂ with 2270 kg of 10-micron CaCO₃ in 2000 m³ of water and to see, at the end of the dissolution reactor 14, how much CO₂ has not reacted, how much carbonate has reacted and how much Ca(OH)₂ is needed to buffer the unreacted CO₂ as a function of residence time and weighted average pressure inside the dissolution reactor 14. Similar tables can be constructed with different particle sizes of CaCO₃ and amounts of water in the mixture 130.

Referring again to the tables in FIG. 5, an experienced person can certainly note that, for example, in the ionic mixture 131 released from the duct 141, approximately 1382 kg di CaCO₃ were dissolved, that approximately 441.1 kg of CO₂ had not reacted and that 407 kg of Ca(OH)₂ were needed in the case of an initial carbonate size of 10 microns, a residence time of 100000 s, a weighted average pressure of 200 bar and a water quantity of 2000 ton/ton_{CO2}.

An experienced person, referring to the tables in FIG. 5, will certainly understand that the amount of dissolved CaCO₃ is the amount of carbonate that must be supplied to the mixer 12 for maximum system efficiency: if the amount of carbonate supplied to the mixer 12 were lower than that indicated in table 4, there would be an excess of CO₂ to be buffered in the ionic mixture 131 while if it were higher there would be the excess part of the carbonate released into the sea with the buffered ionic mixture 132 with wasted carbonate as it would no longer be able to dissolve and form bicarbonates according to the reaction [1].

An experienced person, referring again to the data shown in FIG. 5, will certainly understand that the installation of the dissolution reactor 14 on the seabed compared to installation on land also has a great advantage in terms of the use of space: indeed, the residence times required for a convenient dissolution of carbonate inside the dissolution reactor 14, for an optimisation of the length of the dissolution reactor 14 and for a minimisation of the amount of CO₂ to be buffered in the ionic mixture 131 are in the order of 100000 s (about 28 hours) which, considering a velocity of the mixture inside the dissolution reactor 14 of 0.1 m/s, corresponds to a length of the dissolution reactor 14 of about 10000 m (10 km). It is certainly easier to install a large-diameter duct on the seabed than on land where, in addition to densely populated areas, there may be problems with the orography of the land.

An experienced person will certainly be able to understand that the tubular configuration of the dissolution reactor 14 according to the invention and above all the possibility, known in itself, of making large-diameter pipes of plastic material such as PE by means of a continuous extrusion process, makes it possible to construct EWL reactors with large residence times in a more modular and economical form than the reactors hitherto proposed for storing CO₂ in the form of bicarbonates in the sea.

An experienced person will certainly understand that the dissolution reactor 14 according to the invention can easily handle micronised carbonate which provides a larger reaction surface area than using carbonate with a larger size. In the reactors already proposed for EWL technology, means for the continuous mixing of carbonate with water, such as circulation pumps or agitators, are required, with considerable energy consumption. In the case of the dissolution reactor 14 according to the invention, the very movement of the mixture within the dissolution reactor 14 generates the turbulence necessary to keep the carbonate constantly mixed with the water.

In addition, the installation of the dissolution reactor 14 on the seabed also minimises the energy required to pump water into the dissolution reactor 14 compared to the energy required to pump the same amount of water for a known EWL reactor on land because, in addition to the pressure drop due to the movement of the mixture inside the reactor, there is the pumping energy due to the fact that the reactor on land is generally installed above sea level.

In the event that sizing the duct 141 according to the above criteria poses economic, logistical or environmental problems, it is possible to reduce the length of the duct 141 by supplying more hydroxide 28 to the chamber 123 of the mixer 12. In this case, the carbonic gas 127 reacts with hydroxide 28 according to the reaction:

Ca(OH)₂+2CO₂→Ca(HCO₃)₂.

As an experienced person can understand, in this way it is possible to drastically reduce, or even cancel out, the required length of the duct 141.

Referring to FIG. 2, an experienced person can easily identify the pressure trend inside and outside the apparatus 10 for the preparation of a buffered ionic mixture in case it is installed on the seabed. The pressure Pm inside the mixer 12 is predetermined according to the requirements for mixing the carbonic gas with the water and the carbonate and the pressure drops generated by the motion of the mixture inside the apparatus 10 for preparing the buffered ionic mixture 132; the pressure inside the dissolution reactor 14 comes from the pressure Pr existing in the mixer 12 measured at section 55 added to the hydrostatic pressure proportional to the distance between the measuring point and the sea surface 50 from which the pressure drop is subtracted due to the movement of the mixture inside the apparatus 10 for the preparation of the buffered ionic mixture 132. The pressure Pu is the outlet pressure of the buffered ionic mixture 132 from the pH correction reactor 24.

In a known form, the amount of gaseous CO₂ that is dissolved in the water of the mixture is directly proportional to the partial pressure of the CO₂ in the carbonic gas and inversely proportional to the temperature at which it is inside the apparatus 10 for preparing a buffered ionic mixture.

An experienced person will certainly be able to see that, in order to make the most of the dissolution of CaCO₃ within the dissolution reactor 14 and to minimise the amount of water required in the mixture, it is advisable for the residence time Tₘᵢₙ of the mixture in the reactor to be greater than 1000 s (approx. 17 minutes), preferably comprised between 1500 s (25 minutes) and 10000 s (approx. 3 hours). From a qualitative point of view, the residence time is shorter the smaller the particle size of the CaCO₃ used. Shorter residence times can be achieved, for example, by using what is known as precipitated calcium carbonate (or PCC).

In a known form, in order to prevent sedimentation of the solid components of a slurry, it is necessary to maintain a minimum velocity V₁ (limit velocity) of the slurry in any duct: this velocity is calculated using the well-known Duran formula. For particulate matter in the slurry of less than 50 microns and with a density of less than 2700 kg/m³, no sedimentation problems are considered as long as the velocity of the slurry in the duct is maintained in a turbulent regime, i.e. with a Re≥4000. For example, with a diameter of 3600 mm (3.6 m) already with a slurry velocity inside the duct 141 of 0.1 m/s the turbulent regime criterion is met.

In accordance with some embodiments of the invention, the carbonate is fed to the mixer 12 in the form of a “slurry” suspension by means of the hydroxide supply means 28.

In accordance with a particular embodiment of the invention and with particular reference to FIG. 3 in which the water used to form the mixture within the apparatus 10 for preparing a buffered ionic mixture has an initial pH of 8 a possible behaviour of the pH and the percentage of carbonate 128 and hydroxide 28 not yet dissolved within the apparatus 10 for preparing the buffered ionic mixture 132 is illustrated.

An experienced person can see that the presence of dissolved CO₂ in the ionic mixture 131 lowers its pH because, in its known form, CO₂ reacts with water to form carbonic acid, which in turn splits into a proton H⁺ and a bicarbonate HCO₃⁻ according to the chemical equilibrium CO₂+H₂O↔H₂CO₃↔H⁺+HCO₃⁻ and lowering the pH of the mixture.

An experienced person can calculate that the pH of an ionic mixture 131 consisting of 2000 m³ of water and about 500 kg of dissolved CO₂ has a pH of about 6.

An experienced person can clearly understand that discharging an ionic mixture 131 with a pH of 6 into the surface sea would result in the outgassing of CO₂ to the atmosphere and a loss of efficiency in the storage of CO₂ in the form of bicarbonates, whereas discharging an ionic mixture 131 with a pH of 6 into the deep sea would result in the acidification of the sea as CO₂ remains dissolved in the deep sea. This is what happens in the proposed EWL reactors.

An experienced person will certainly understand that, in order not to damage the environment, it is necessary and appropriate to buffer the ionic solution 131 with a hydroxide. In this case the hydroxide would react with the remaining dissolved CO₂, eliminating the problems of both acidification and outgassing mentioned above.

An experienced person may understand that it is possible to use hydroxide to correct the pH of the ionic mixture 131 released from the dissolution reactor 14 and fed to the pH correction reactor 24, buffering all or part of the CO₂, still present therein, to release a buffered ionic mixture 132 with the desired pH into the sea using the equation:

2CO2_{(aq)}+Ca(OH)_{2(aq)}=>Ca²⁺_{(aq)}+2HCO³⁻_{(aq)} [2]

An experienced person can certainly understand that a certain amount of mixing time is required inside the reactor for the pH correction 24 of the hydroxide 28 with the ionic mixture 131 in order for the buffered ionic mixture 132 to be formed with a homogeneous pH throughout its volume, especially if the hydroxide 28 is supplied to the pH correction reactor 24 not in the form of a solution but in the form of a suspension (slurry) or in solid form.

An experienced person can understand that the duct 142 of the pH correction reactor 24 must have a sufficient length to ensure proper mixing of the hydroxide 28 with the ionic mixture 131: this length is comprised between 0 m and 20000 m, preferably between 10 m and 1000 m.

An experienced person can understand that the duct 142 of the pH correction reactor 24 may be provided with suitable means for mixing the hydroxide 28 with the ionic mixture: such mixing means, not shown in the figures, may be static mixers or a suitable arrangement of the hydroxide injection nozzles 28.

In accordance with a particular embodiment of the invention, in the event that the hydroxide 28 is a hydroxide with a high Mg content and therefore low solubility, it is convenient that the buffered ionic mixture 132 is released into the sea from the pH correction reactor 24 in the form of a suspension (slurry) with a part of the hydroxide not yet dissolved so that it can finish dissolving and buffering according to the reaction [2] in the plume 25. In such a case, the pH of the buffered ionic mixture 132 in section 65 would be lower than that of the surrounding seawater and would only reach the desired value after the hydroxide 28 finalises its dissolution in the plume 25.

In accordance with some embodiments of the invention and referring to FIG. 1.c, the hydroxide supply means 28 may be implemented by a hydroxide dispenser 281 positioned in the logistics base 300 and by an auxiliary tube 282 running parallel or coaxially to the duct 141. The dispenser 281 can be conveniently implemented by means of a dosing pump for pumping an ionic hydroxide solution 28 or a suspension of water and hydroxide 28. This dosing pump would be controlled by the control unit 230 according to the signal received from the meter 23.

Referring to the table in FIG. 6, an experienced person can certainly identify the parameters of the different steps of the process under consideration in which:
column (A) corresponds to the chemical and physical condition of water 26 taken from the sea surface 50;
column (B) corresponds to the chemical and physical condition of the water in contact with the CO₂ in the mixer 12;
column (C) corresponds to the chemical and physical condition of the rich mixture 131 released from the dissolution reactor 14 and referring to section 60;
column (D) corresponds to the chemical and physical condition of the buffered ionic mixture 132;
column (E) corresponds to the chemical and physical condition of the buffered ionic mixture mixed with seawater in the plume 25 in a ratio of 1:20 representing the final equilibrium condition.

An experienced person can certainly understand that with the apparatus 10 for preparing a buffered ionic mixture according to the invention, conveniently exploiting the effect of the hydrostatic pressure of the tubular dissolution reactor 14 laid on the seabed, long residence times and small carbonate size, it is possible to reduce the amount of water and the time required for carbonate dissolution almost by an order of magnitude compared to the reactors already proposed for EWL technology with obvious economic and applicability benefits. Furthermore, the apparatus 10 for preparing a buffered ionic mixture according to the invention does not have the problems of CO₂ outgassing or sea acidification typical of the EWL reactors proposed so far.

A second aspect of the invention relates to a method for the accelerated dissolution of carbonates with buffered pH. Said method comprises the steps of:
providing an apparatus 100 for the accelerated dissolution of carbonates with buffered pH in accordance with the above;
supplying the mixer 12 with predetermined flow rates of water 26, carbonic gas 127 and carbonate 128 in order to obtain a design flow rate of lean mixture 130;
conveying the lean mixture 130 into the dissolution reactor 14;
keeping the mixture in the dissolution reactor 14 for the minimum time necessary to dissolve any carbonates in the lean mixture 130 according to the reaction

CaCO₃₍ₐ₎+CO_{2(aq)}+H₂O→Ca(HCO₃)_{2(aq)}
calculated at the design flow rate;
keeping the mixture inside the dissolution reactor 14 in a turbulent regime with a Re≥4000;
releasing the ionic mixture 131 from the dissolution reactor 14 into the pH correction reactor 24;
defining a desired pH of the buffered ionic mixture 132 to be released into the sea;
supplying the pH correction reactor 24 with hydroxide 28;
mixing the ionic mixture 131 with hydroxide 28 to obtain a buffered ionic mixture 132 having the desired pH by the reaction

Ca(OH)_{2(aq)}+2CO_{2(aq)}→Ca(HCO₃)_{2(aq)};e
releasing the buffered ionic mixture 132 with the desired pH into the sea.

The method described above may also comprise the steps of:
providing the pH and/or alkalinity and/or hardness meter 23;
providing the control system 230 adapted to receive the measurement from the meter 23, processing the measurements received and commanding the hydroxide supply means 28;
measuring the pH and/or hardness and/or alkalinity in the ionic mixture 131 or in the buffered ionic mixture 132;
calculating the correct flow rate of hydroxide 28 to be mixed with the ionic mixture 131 to obtain the buffered ionic mixture 132;
commanding the hydroxide supply means 28 to supply the correct flow rate of hydroxide 28; and
releasing the buffered ionic mixture 132 from the pH correction reactor 24 into the sea.

It is understood that the specific features are described in relation to different embodiments of the apparatus 100 for the accelerated dissolution of carbonates with buffered pH aimed at permanent sequestration of CO₂ in the form of bicarbonates with an illustrative and non-limiting intent.

To the apparatus 100 for the accelerated dissolution of carbonates with buffered pH for the permanent sequestration of CO₂ in the form of bicarbonates according to the present invention, a person skilled in the art may, in order to meet contingent and specific requirements, make further modifications and variations, all of which are within the scope of protection of the invention as defined by the following claims.

1-13. (canceled)

14. A method for the accelerated dissolution of pH-buffered carbonates: the method comprising:
providing an apparatus for the accelerated dissolution of pH-buffered carbonates, the apparatus comprising a mixer, a dissolution reactor, and a pH correction reactor;
supplying the mixer with predetermined flow rates of water, carbonic gas, and carbonate in order to obtain a design flow rate of lean mixture;
conveying the lean mixture into the dissolution reactor;
keeping the lean mixture in the dissolution reactor for a minimum time necessary to dissolve any carbonates in the lean mixture according to the reaction:
CaCO₃₍ₛ₎₊CO2_{(aq)}+H₂O→Ca(HCO₃)_{2(aq)}
calculated at the design flow rate, so as to obtain an ionic mixture;
keeping the mixture inside the dissolution reactor in a turbulent regime with a Re≥4000;
releasing the ionic mixture from the dissolution reactor into the pH correction reactor;
defining a desired pH of the buffered ionic mixture to be released into the sea;
supplying the pH correction reactor with hydroxide;
mixing the ionic mixture with a predetermined amount of hydroxide to obtain a buffered ionic mixture having the desired pH by the reaction:
Ca(OH)_{2(aq)}+2CO_{2(aq)}→Ca(HCO₃)_{2(aq)}; and
releasing the buffered ionic mixture with the desired pH into the sea.

15. The method according to claim 14, further comprising:
providing the pH correction reactor with hydroxide supply means;
providing a pH and/or alkalinity and/or hardness meter;
providing a control system configured to receive the measurement from the meter, processing the measurements received and commanding the hydroxide supply means;
measuring the pH and/or hardness and/or alkalinity in the ionic mixture or in the buffered ionic mixture;
calculating the correct flow rate of hydroxide to be mixed with the ionic mixture to obtain the buffered ionic mixture;
commanding the hydroxide supply means to supply the correct flow rate of hydroxide; and
releasing the buffered ionic mixture from the pH correction reactor into the sea.

16. The method according to claim 15, further comprising:
dissolving 1382 kg of carbonate into 2000 m³ of water and 1000 kg of CO₂ to form the lean mixture;
conveying the lean mixture into the dissolution reactor;
waiting 100,000 s in order to dissolve any carbonates in the lean mixture according to the reaction:
CaCO₃₍ₛ₎₊CO2_{(aq)}+H₂O→Ca(HCO₃)_{2(aq)}
to obtain an ionic mixture;
releasing the ionic mixture from the dissolution reactor into the pH correction reactor;
adding 407 kg of hydroxide to the ionic mixture to obtain the buffered ionic mixture.

17. The method according to claim 15, further comprising: using precipitated calcium carbonate PCC as carbonate to accelerate the dissolution of the carbonate into the dissolution reactor.

18. The method according to claim 15, further comprising using micronized carbonate as carbonate to accelerate the dissolution of the carbonate into the dissolution reactor.
